(19) United States
(12) Patent Application Publication
(10) Pub. No.: US 2012/0185838 A1
(43) Pub. Date: Jul. 19, 2012

(54) METHOD AND SYSTEM FOR SECURE FIRMWARE UPDATES IN PROGRAMMABLE DEVICES

(76) Inventors: Ido Schwartzman, Tel Aviv (IL); Liran Katzir, Herzylia (IL)

(21) Appl. No.: 13/323,888

(22) Filed: Dec. 13, 2011

Related U.S. Application Data
(60) Provisional application No. 61/433,279, filed on Jan. 17, 2011.

(30) Foreign Application Priority Data
Jul. 18, 2011 (GB) GB1112294.2

(51) Int. Cl. G06F 9/44; G06F 1/26; G06F 11/30; G06F 1/24

(52) U.S. Cl. 717/168

(57) ABSTRACT

A method in a computerized system including a microprocessor adapted to run a previously installed firmware code. The computerized system is adapted to receive power from an alternating current (AC) power supply. The AC power supply may include either an AC generator or an AC output of direct current (DC) to AC inverter. The frequency is monitored for a frequency variation pattern of the AC power supply. Optionally, the frequency is monitored upon receiving a request to update the firmware code. Upon recognizing the frequency variation pattern, a firmware update of the firmware code is enabled.

### CROSS REFERENCE TO RELATED APPLICATIONS

The present application claims priority from U.S. provisional application 61/433,279 filed on Jan. 17, 2011 by the same inventor and United Kingdom patent application serial number GB1112294.2 filed Jul. 18, 2011 in the United Kingdom Intellectual Property Office by the same inventors, the disclosures of which are incorporated herein by reference.

### BACKGROUND

1. Technical Field

The present invention relates to securing data processing devices connected to alternating current (AC) power networks.

2. Description of Related Art

Many devices today make use of computational elements controlled by software instructions embedded in a device to give the device its functional personality. The software instructions, are often called firmware because of persistent association with the device hardware operation. Firmware historically was placed in read-only memory (ROM) and was activated when the device was powered on. With time, it was recognized that firmware, like other forms of software, might be subject to coding mistakes and that over the lifetime of the device there was a need to modify the functional characteristics of the device, for example, to adapt the device to a new target environment. Repair of firmware coding errors and/or modify firmware functionality led to the use of field-programmable random-access memory (RAM) as a repository for on-device firmware. Re-programming of firmware on field-programmable random-access memory (RAM) provided an easier means of modification than replacing ROM chips.

Typically firmware can be updated without physical hardware modification, using removable digital media or a network connection as the mechanism by which new firmware is communicated to the device. The extensive increase in network connectivity in recent years has resulted in an increase in the number of firmware-driven devices that allow for functional updates. With the increasing number of update capable devices may come significant security problems. Given the ubiquitous nature of firmware-driven devices, such security problems may extend to homes, businesses and other areas where such devices are utilized. For example, personal computers, cell phones, satellite receivers, set-top boxes, cable and DSL modems, routers, digital TVs, or even appliances like refrigerators, sewing machines, and ovens may all be susceptible to such security problems. More recently, the appearance of “Smart Grid” devices, such as smart meters and remote-controllable power switching devices, has opened up the risk of planned cyber attacks on the power infrastructure through the spreading of malicious, unauthorized firmware updates. Since these devices are essential for the operation of modern “Smart Grid” networks and the environmental and economic benefits they provide, securing them is a high priority.

Other devices that may benefit from added security are “Supervisory Control and Data Acquisition” (SCADA) devices—these industrial control systems that monitor and control industrial, infrastructure, or facility-based processes. Vendors of SCADA and control products have begun to address the risks posed by unauthorized access by developing lines of specialized industrial firewall and VPN solutions for TCP/IP based SCADA networks as well as external SCADA monitoring and recording equipment.

A feature common to SCADA networks used by an industrial infrastructure may be a source of alternating current (AC) supply which may be independent of, or in addition to a mains grid supplied by a utility company. The source of alternating current (AC) supply is often generated by the industrial infrastructure to avoid problems of power outage of the mains electricity grid. As such, the source of alternating current (AC) supply generated by the industrial infrastructure may be adjusted in terms of voltage amplitude, phase or frequency by the industrial infrastructure. Smart Grid devices, on the other hand, usually receive their power from nationwide power supply grids, such as the United Kingdom National Grid.

United Kingdom (UK) National Grid has a license obligation to control frequency within the limits specified in the ‘Electricity Supply Regulations, i.e. ±1% of nominal system frequency (50.00 Hz) save in abnormal or exceptional circumstances (The Electricity Supply Regulations 1988, No. 1057, PART VI, Regulation 30, Section 2). UK National Grid typically ensures that sufficient generation and/or demand is controlled so as to manage all credible circumstances that might result in frequency variations. As electricity is difficult to store, the instantaneous generation typically matches the demand being taken from the system. If the instantaneous demand is higher than the generation, the system frequency may fall. Conversely, if the instantaneous generation is higher than the demand, the frequency may rise. System frequency will therefore vary around the 50 Hz target and National Grid has statutory obligations to maintain the frequency as mentioned. There are two types of frequency response used to manage and control the frequency of the system; dynamic and non dynamic frequency response. Dynamic frequency response is a continuously provided service used to manage and control the normal second by second changes on the system. While non dynamic frequency response is usually a discrete service triggered at a defined frequency deviation.

Regulation of power system frequency for timekeeping accuracy was not commonplace until after 1926 and the invention of the electric clock driven by a synchronous motor. Network operators regulate the daily average frequency so that traditional electrical clocks stay within a few seconds of correct time. In practice the nominal frequency is raised or lowered by a specific percentage to maintain synchronization. Over the course of a day, the average frequency is maintained at the nominal value within a few hundred parts per million. In the synchronous grid of Continental Europe, the deviation between network phase time and UTC (based on International Atomic Time) is calculated at 08:00 each day in a control center in Switzerland, and the target frequency is then adjusted by up to ±0.01 Hz (±0.02%) from 50 Hz as needed, to ensure a long-term frequency average of exactly 24×3600×50 cycles per day is maintained. In North America, whenever the error exceeds 10 seconds for the east, 3 seconds for Texas, or 2 seconds for the west, a correction of ±0.02 Hz (0.033%) is applied. The North American Electric Reliability Corporation (NERC) discusses a proposed experiment that would relax frequency regulation requirements for electrical grids which would reduce the long-term accuracy of clocks and other devices that use the 60 Hz grid frequency as a time base.

The terms “alternating current (AC) network”, “AC power supply” and “power network” as used herein are used interchangeably and refer to an AC power source which powers industrial, infrastructure, or facility-based processes. The AC power source typically supplies power to industrial, infrastructure, or facility-based processes separately thereto or in addition with an AC mains grid provided from an electricity utility company. The AC power source is typically derived from an AC generator or the output of a direct current (DC) to AC inverter. A DC input of the DC to AC inverter may be from a photovoltaic array, fuel cells, batteries or DC generator.

The term “firmware” as used herein refers to the programs and/ or data structures that are responsible for system hardware operation. The terms “firmware” and “software” are used herein interchangeably.

The term “rollback” as used herein refers to an operation which returns firmware to a previous state.

The term “latch” as used herein refers to a circuit that has two stable states which forms a data storage element and can be used to store state information. The circuit can be made to change state by signals applied to one or more control inputs and will have one or two outputs.

### BRIEF SUMMARY

According to aspects of the present invention there is provided a method for securing a computerized system including a microprocessor adapted to run a previously installed firmware code. The computerized system is adapted to receive power from an alternating current (AC) power supply. The AC power supply may include either an AC generator or an AC output of direct current (DC) to AC inverter. The frequency is monitored for a frequency variation pattern of the AC power supply. Optionally, the frequency is monitored upon receiving a request to update the firmware code. The request to update the firmware code may be in response to a malicious or cyber attack on the computerized system, such as a “virus” or “worm”. Upon recognizing the frequency variation pattern, a firmware update of the firmware code is enabled. Optionally, the frequency variation pattern is previously determined and only upon recognition of the previously determined frequency variation pattern then the enablement of the firmware update is allowed during a limited time interval after the recognition of the previously determined frequency variation pattern. Optionally, the firmware code is stored locally, for instance, in non-volatile non-programmable non-erasable read only memory (ROM) attached to the microprocessor. The firmware update may be loaded into a programmable read only non-volatile memory (PROM) attached to the microprocessor. The microprocessor may be reset using the firmware update from the PROM. Upon recognizing the pattern of frequency variation, a time interval may be measured and the resetting of the microprocessor is performed only during the time interval.

According to aspects of the present invention there is provided a computerized system including a microprocessor. The computerized system may be adapted to receive power from an alternating current power supply. Storage is operatively attached to the microprocessor. The storage is adapted to store in the computerized system executable code executable by the microprocessor. The storage may be adapted to store locally, in the computerized system, executable code which may be executed by the microprocessor. Optionally, the storage is attached locally to the microprocessor. The local storage may include a non-programmable non-volatile read only memory (ROM) attached locally to the microprocessor in the computerized system. A frequency sampler unit connectible to the AC power supply may be adapted to sense a frequency pattern of the alternating current of the AC power supply. The computerized system may be operable to update the executable code by loading the executable code for access by the microprocessor. The loading of the executable code stored in the storage may be performed responsive to the frequency sampler unit sensing a frequency pattern variation of the AC power source. The frequency pattern variation of the AC power may be previously determined. Optionally, the local storage is adapted to store a firmware rollback in the event of a cyber attack, e.g. worm or virus, on the computer system. A latch including a set input may be operatively connected to a first output of the frequency sampler unit. The microprocessor may be configured to operate the latch and program code stored in the local storage, e.g. ROM based on the recognized pattern of the frequency pattern. The microprocessor includes a latch reset output operatively connected to a latch reset input of the latch. The latch includes an output Q operatively connected to the ROM. The first output is operatively attached to the set input of the latch and a second output of the frequency sampler unit operatively is attached to the microprocessor. The second output of the frequency sampler unit is connected to a reset input of the microprocessor to reset the microprocessor. The microprocessor operatively connected to the second output of the frequency sample. A communication port may be operatively attached to the microprocessor.

### BRIEF DESCRIPTION OF THE DRAWINGS

The invention is herein described, by way of example only, with reference to the accompanying drawings, wherein:

FIG. 1 shows a system used for performing a firmware update of a programmable memory, according to an aspect of the present invention.

FIG. 2 shows a method used for the system shown in FIG. 1, according to an aspect of the present invention.

FIG. 3 shows a system used for performing a firmware update of a PROM, according to an aspect of the present invention.

FIG. 4 shows a method used to operate the system shown in FIG. 3, according to an aspect of the present invention.

### DETAILED DESCRIPTION

Reference will now be made in detail to aspects of the present invention, examples of which are illustrated in the accompanying drawings, wherein like reference numerals refer to the like elements throughout. The embodiments are described below to explain the present invention by referring to the figures.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, embodiments of the present invention are directed to a method and a system which provides secure updating and/or rollback of firmware by way of example for Smart Metering Devices and/or SCADA systems connected to a power network. The power network typically supplies power to industrial, infrastructure, or facility-based processes of SCADA systems and frequency of the power network may be adjusted according to a pattern of frequency variation. The basis for both updating and/or rollback of firmware is to identify the pattern of frequency variation of AC power supplying the SCADA system, thereby ensuring updates authorized by a relevant body. Embodiments are additionally directed to a roll back of firmware where in other SCADA systems and/or smart metering systems it may be impossible to “roll-back” to the previous, healthy firmware version, since a malicious update may include a protection against further updates.

At any given time, a power network operates at a given frequency, which typically fluctuates due to variations of loading on the power network. The control of frequency is normally within electrical standards, for instance within ±1% of nominal system frequency (50.00 Hz). A pattern of variation of frequency within ±1% of nominal system frequency by control of the power network to an outside observer may be considered typical fluctuations due to variations of loading on the power network. Alternatively, in other embodiments of the present invention, the alternating current power supply may be off-grid. Examples, of off-grid alternating current power supplies include an AC generator, an AC fuel burning power plant, solar thermal or wind energy, and/or an AC inverter attached to a distributed power source, e.g. photovoltaic solar power source. In an off-grid implementation, frequency may be varied more considerably.

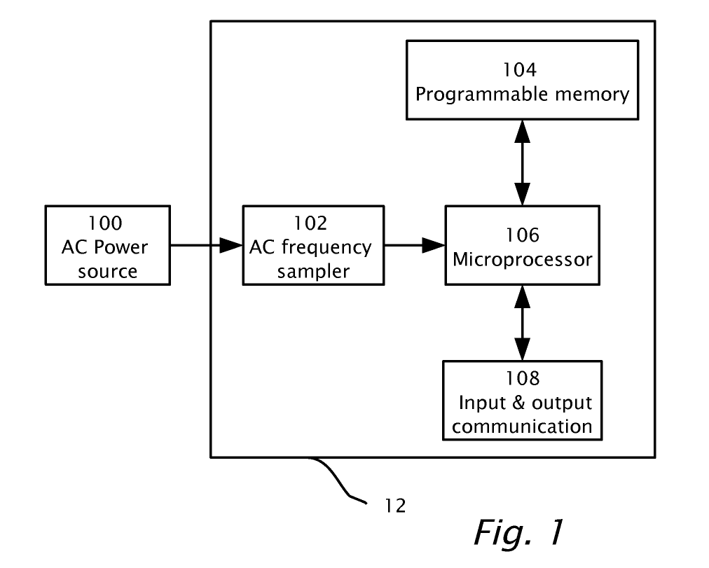

Reference is now made to FIG. 1 which shows a system 12 used for performing a firmware update of a programmable memory 104, according to an embodiment of the present invention. Examples of system devices 12 typically include wireless routers, programmable logic controllers (PLCs) and controllers which may be part of a system for supervisory control and data acquisition (SCADA) or part of a smart meter or other device in the electric grid. Frequency sampler 102, microprocessor 106, memory 104 and I/O 108 are typical elements included in system device 12. AC frequency sampler has an input from AC power source 100 and an output to microprocessor. Microprocessor 106 is bi-directionally attached to programmable memory 104 and to input/output (I/O) communication port 108. A power network 100 is operatively attached to alternating current (AC) frequency sampler 102. Sampler 102 typically includes an analogue to digital converter (ADC) and an output connected to microprocessor 106.

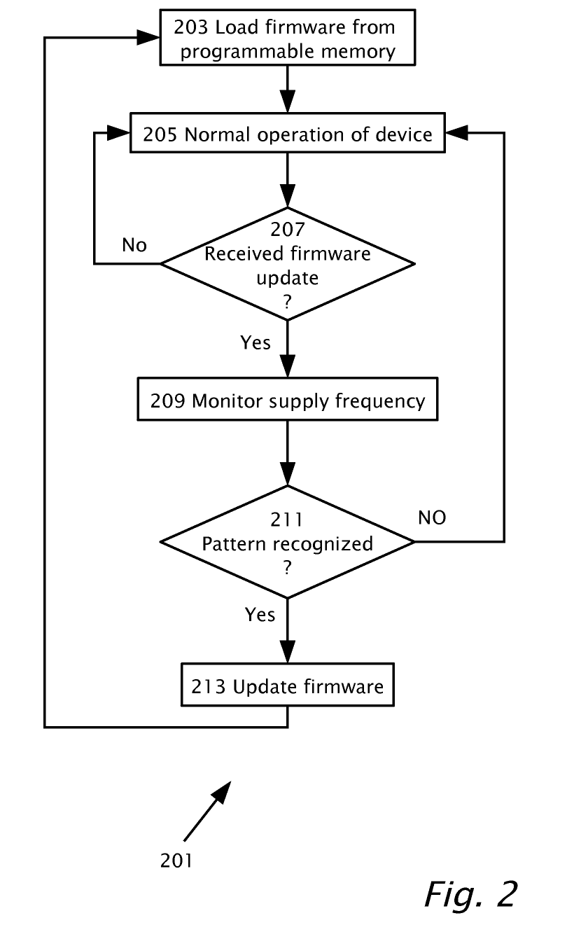

Reference is now made to FIG. 2 which shows a method 201 used for system 12 shown in FIG. 1, according to an embodiment of the present invention. In step 203 microprocessor 106 is loaded with firmware code from programmable memory 104 and normal operation of device 12 continues in step 205. Upon receiving an optional request for a firmware update through the I/O communication port 108 (decision block 207), device 12 begins monitoring (step 209) the frequency of power network 100 during a time interval using sampler 102.

Otherwise, in decision block 207, if an external request for a firmware update is not received, normal operation of device 12 continues in step 205. In decision step 211 a test is performed for a predetermined pattern of frequency change during a time interval. After the time interval has elapsed, if the pattern of frequency change has been recognized, system 12 enables storing of the firmware in memory 104 (step 213) and microprocessor 106 may be loaded with the updated firmware code from the updated firmware now stored in programmable memory 104 in step 203. If in decision block 211, the pattern of frequency change has not been recognized, system 12 continues normal operation in step 205 with firmware in programmable memory 104 which has not been updated.

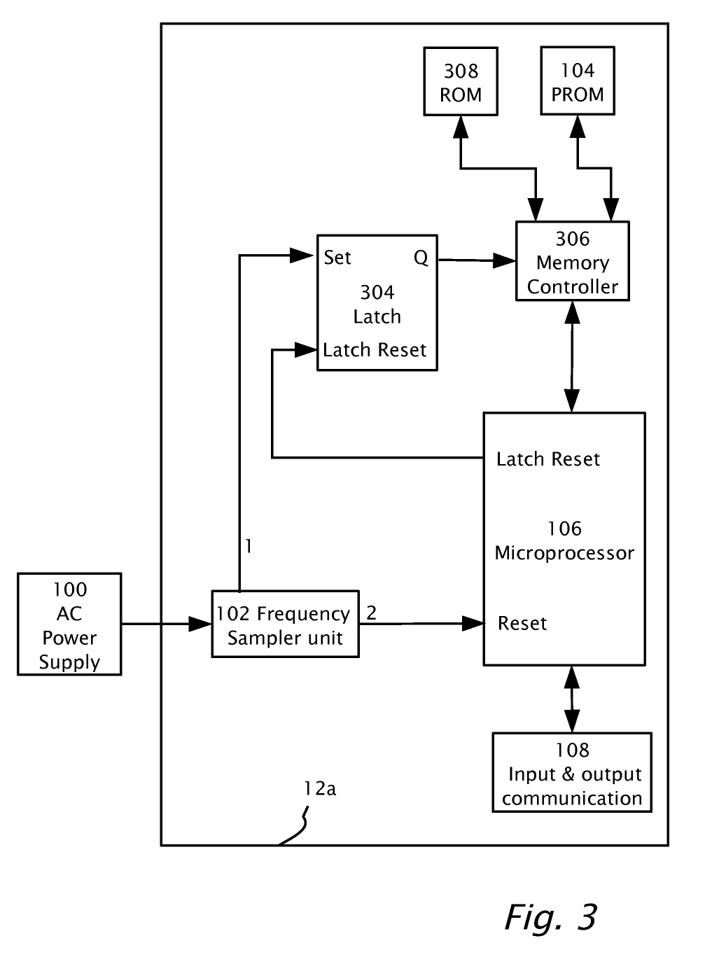

Reference is now made to FIG. 3 which shows more details of system 12, in a system 12a used for performing a firmware update of a PROM 104, according to an embodiment of the present invention. AC frequency sampler 102 has an input from AC power source 100 and a reset output to microprocessor 106. Microprocessor 106 is bi-directionally attached to programmable memory 104 and to input/ output (I/O) communication port 108. Controller 306 receives an output Q of latch 304 and is also bi-directional attached to read only memory 308 and programmable read only memory 104. Latch 304 receives a Latch Reset from microprocessor 106 and a Set input from sampler 102. Power source 100 is operatively attached to alternating current (AC) sampler 102. Sampler 102 also provides a Reset output to microprocessor 106.

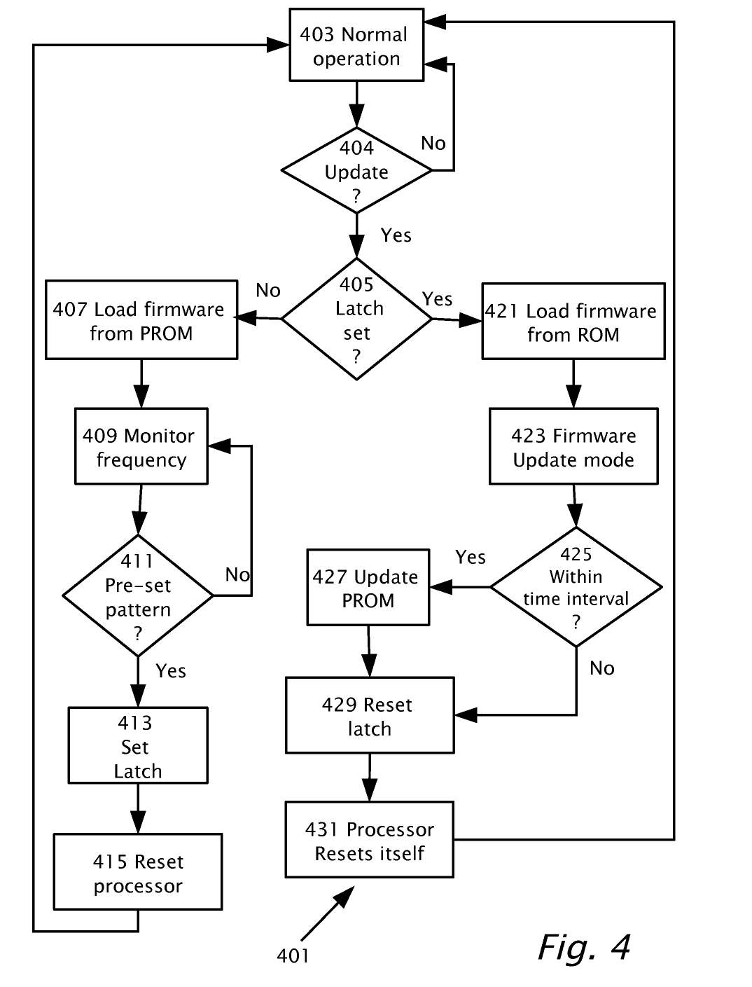

Reference is now made to FIG. 4 which shows a method 401 used to operate system 12a shown in FIG. 3, according to an embodiment of the present invention. Method 401 typically provides a rollback feature for firmware updates of device 12a. The rollback feature of device 12a typically allows resetting of device 12a to an authorized firmware code in ROM 308, even if a malicious update rewrote the firmware with code that does not allow updating.

In normal operation (step 403) system 12a operates with firmware stored in programmable read only memory (PROM) 104. In decision step 404 normal operation continues if a request for a firmware update is not received by I/O port 108. If a firmware update is received by I/O port 108 then an option of update of firmware and/ or the rollback feature is provided in decision step 405.

The rollback feature of device 12a is achieved by the inclusion of latch 304 and memory controller 306 which allows selection of either ROM 308 or PROM 104 in decision step 405. By default, device 12a normally runs with firmware code from PROM 104 with latch 304 not set. With latch 304 not set in decision 405, sampler 102 monitors the frequency of power network 100. If a preset pattern in the variation of the frequency does not occur, then monitoring of the frequency continues with step 409. If a preset pattern in the variation of the frequency does occur in decision 411, then latch 304 is set in step 413. Microprocessor 106 is then reset on the Reset input of microprocessor 106 by sampler unit 102 in step 415, followed by normal operation of device 12a in step 403.

With a firmware update received by I/O port 108 in step 405 and latch 304 set, microprocessor 106 now loads with code from ROM 308 (step 421) (as opposed to the programmable memory, which is the default). Microprocessor 106 is now in firmware update mode (step 423) and decision step 425 decides if the firmware update in step 423 has been performed in a period of time known as a time window. If the firmware update in step 423 has been performed in the period of time then PROM 104 is updated (step 427) and microprocessor 106 resets latch 304 on Latch Reset in step 429. If the firmware update in step 423 has not been performed in the period of time, PROM 104 is not updated, device 12a is therefore, rolled back and microprocessor 106 resets latch 304 on Latch Reset in step 429. After step 429 microprocessor 106 resets itself in step 431 followed by normal operation of device 12a in step 403 with the programming code from programmable memory 104 which is either a rolled back ROM version or an updated firmware version as a result of step 427.

The pattern of changes in monitored frequency (step 409) may be defined over a time period, and may include a margin for measurement errors, delayed propagation of power network frequencies in large networks, minute differences in internal clocks, and other unforeseen measurement errors. The differences between the different points (highs and lows) of the pattern of frequency changes from supply 100 should be large enough to be measurable and for a grid tied application, optionally within statutory limits of allowable frequency variations from the nominal supply frequency of 50 Hertz or 60 Hertz. The time intervals between the different time slots of the pattern of frequency changes from supply 100 are long enough to be measurable, typically in the range 0.1 to 10 sec. Any number of discrete or non-discrete frequency changes may be used in the frequency pattern variation.

The definite articles “a”, “an” is used herein, such as “a unit”, “an update” have the meaning of “one or more” that is “one or more units” or “one or more updates”.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

We claim:

1. A method for securing a computerized system including a microprocessor adapted to run a previously installed firmware code, the method comprising the steps of:
receiving power from an alternating current (AC) power supply;
monitoring frequency of said AC power supply for a frequency variation pattern; and
upon recognizing said frequency variation pattern, enabling a firmware update of the firmware code.

2. The method of claim 1, wherein only upon said recognizing said frequency variation pattern, then enabling said firmware update.

3. The method of claim 1, further comprising the step of:
previously determining said frequency variation pattern; and
only upon said recognizing said previously determined frequency variation pattern then enabling said firmware update during a limited time interval after said recognizing.

4. The method of claim 1, further comprising the step of:
receiving a request to update the firmware of the microprocessor and performing said monitoring frequency upon receiving said request.

5. The method of claim 1, further comprising the step of:
resetting to an authorized firmware code if a malicious update rewrote the previously installed firmware.

6. The method of claim 1, wherein said AC power supply selected from the group consisting of: an AC generator and an AC output of direct current (DC) to AC inverter.

7. The method of claim 1 further comprising the step of:
storing said firmware code locally in local storage attached to said microprocessor.

8. The method of claims 7, wherein said local storage includes non-volatile non-programmable non-erasable read only memory (ROM)

9. The method of claim 1, further comprising the step of:
performing said firmware update from a firmware code stored locally in local storage attached to said microprocessor.

10. The method of claims 9, further comprising: resetting to an authorized firmware code if a malicious update rewrote the previously installed firmware.

11. The method of claim 9, further comprising the steps of:
loading said firmware update into a programmable read only non-volatile memory (PROM) attached to said microprocessor; and
resetting said microprocessor using said firmware update from said PROM.

12. The method of claim 11, further comprising the steps of:
upon said recognizing said pattern of frequency variation, measuring a time interval; and
performing said resetting of said microprocessor only during said time interval.

13. A computerized system including a microprocessor, wherein the computerized system is adapted to receive power from an alternating current power supply, the computerized system comprising:
storage operatively attached to the microprocessor, wherein said storage is adapted to store in the computerized system a firmware update executable by the microprocessor; and
a frequency sampler unit connectible to the AC power supply, wherein the frequency sampler unit is adapted to sense a frequency pattern of the alternating current of the AC power supply;
wherein the computerized system is operable to update said executable code by loading the executable code for access by the microprocessor, wherein the firmware update is stored in said storage, wherein said loading the firmware update is performed responsive to the frequency sampler unit sensing a frequency pattern variation of said AC power source.

14. The computerized system of claim 13, wherein said storage includes local storage attached to the microprocessor, wherein said local storage is adapted to store locally in the computerized system said firmware update executable by the microprocessor.

15. The computerized system of claim 14, wherein said local storage is adapted to store a firmware rollback in the event of a cyber attack on the computerized system.

16. The computerized system of claim 14, wherein said local storage includes non-programmable non-volatile read only memory (ROM).

17. The computerized system of claim 16, further comprising:
a latch including a set input operatively connected to a first output of said frequency sampler unit, wherein the microprocessor includes a latch reset output operatively connected to a latch reset input of said latch, wherein said latch includes an output Q operatively connected to the ROM.

18. The computerized system of claim 17, wherein said frequency sampler unit includes:
said first output operatively attached to the set input of said latch; and
a second output operatively attached to said microprocessor; and
said microprocessor operatively connected to said second output of said frequency sample and, wherein said microprocessor is configured to operate said latch and the firmware update stored in said storage based on a recognized pattern of said frequency pattern.

19. The computerized system of claim 18, wherein said second output of the frequency sampler unit is connected to a reset input of the microprocessor to reset the microprocessor.

20. The computerized system of claim 13, further comprising a communication port operatively attached to said microprocessor.
